(19) United States
(12) Patent Application Publication
(10) Pub. No.: US 2024/0136702 A1
(43) Pub. Date: Apr. 25, 2024

(54) TERMINAL ANTENNA AND ELECTRONIC DEVICE

(71) Applicant: HONOR DEVICE CO., LTD., Shenzhen, Guangdong (CN)

(72) Inventors: Simin HOU, Shenzhen (CN); Kunpeng WEI, Shenzhen (CN); Hang MENG, Shenzhen (CN); Qiao GUAN, Shenzhen (CN)

(21) Appl. No.: 18/547,846

(22) PCT Filed: Aug. 24, 2022
(86) PCT No.: PCT/CN2022/114841

§ 371 Date: Aug. 23, 2023

(30) Foreign Application Priority Data
Oct. 26, 2021 (CN) 202111257249.7

(51) Int. Cl. H01Q 1/24; H01Q 1/38; H01Q 1/48; H01Q 21/30

(52) U.S. Cl. CPC H01Q 1/243; H01Q 1/38; H01Q 1/48; H01Q 21/30

(57) ABSTRACT

Embodiments of this application disclose a terminal antenna and an electronic device, and relate to the field of antenna technologies, which can better cover a medium-high frequency band, provide a good bandwidth and good radiation performance, reduce hardware costs, and have a good SAR, thereby better supporting a wireless communication function of the electronic device. A specific solution is as follows: The terminal antenna includes: a first radiator, a feed point, and a ground point. One end of the first radiator is grounded by using the ground point, and the other end of the first radiator is provided with the feed point. The first radiator is further provided with a slot that penetrates the first radiator, the slot is of an interdigital structure, and there are at least two slots.

This application claims priority to Chinese Patent Application No. 202111257249.7, filed with the China National Intellectual Property Administration on Oct. 27, 2021 and entitled “TERMINAL ANTENNA AND ELECTRONIC DEVICE”, which is incorporated herein by reference in its entirety.

### TECHNICAL FIELD

This application relates to the field of antenna technologies, and in particular, to a terminal antenna and an electronic device.

### BACKGROUND

With development of electronic devices, an environment that can be provided for an antenna in the electronic device is becoming poorer. To ensure a wireless communication function of the electronic device (for example, a mobile phone), an antenna solution with good radiation performance needs to be provided in a poor environment. It is increasingly difficult to ensure radiation performance in current space in an existing antenna solution. Therefore, a new antenna solution is required to meet another antenna requirement, for example, meet an SAR requirement for an antenna, while providing good radiation performance.

### SUMMARY

Embodiments of this application provide a terminal antenna and an electronic device, which can better cover a medium-high frequency band (for example, 1.7 GHz-2.7 GHz), provide a good bandwidth and good radiation performance, reduce hardware costs, and have a good SAR, thereby better supporting a wireless communication function of the electronic device.

To achieve the foregoing objective, the following technical solutions are used in the embodiments of this application.

According to a first aspect, a terminal antenna is provided. The terminal antenna is disposed in an electronic device, and the terminal antenna includes: a first radiator, a feed point, and a ground point. One end of the first radiator is grounded by using the ground point, and the other end of the first radiator is provided with the feed point. The first radiator is further provided with a slot that penetrates the first radiator, the slot is of an interdigital structure, and there are at least two slots.

Based on the solution, a new antenna structure is provided, which can be applied to antenna design of the electronic device (for example, a mobile phone). In this example, the solution may be applied to design of a lower antenna of a mobile phone. The interdigital structure may be disposed on the antenna to form a distributed capacitor, so as to obtain a radiation feature of a current loop antenna by connecting a capacitor in series to a radiator. In addition, because the ground point is disposed at an end away from the feed point, a loop (loop) mode or the like can be further excited. Therefore, at least two operating modes are used, so that the electronic device in which the terminal antenna is disposed can have a good wireless communication capability due to good radiation performance such as good bandwidths and good efficiency of the two modes.

In a possible design, an operating frequency band of the terminal antenna includes at least a first frequency band and a second frequency band, the terminal antenna covers the first frequency band by using a resonance corresponding to a zero-order mode, and the resonance corresponding to the zero-order mode is generated by the slot of the interdigital structure. The terminal antenna covers the second frequency band by using a resonance corresponding to a Loop mode, and the first frequency band is different from the second frequency band. Based on the solution, a mechanism for covering the operating frequency band by the terminal antenna is provided. For example, the zero-order mode (that is, a mode generated by a current loop) may generate a resonance, and the resonance in the loop mode may further generate a resonance. In this way, the two resonances can cover at least two operating frequency bands required by the electronic device.

In a possible design, the slot is filled with a dielectric, the dielectric and the first radiator have different dielectric constants, and when different dielectrics are filled, the resonance corresponding to the zero-order mode covers different frequency bands. Based on the solution, a specific implementation of the slot is provided. In this example, a dielectric whose dielectric constant is different from that of the first radiator may be filled in the slot. A size of a distributed capacitor corresponding to the slot can be adjusted by adjusting the dielectric constant of the dielectric, so as to adjust a frequency band range of the resonance corresponding to the zero-order mode.

In a possible design, when lengths of the first radiator are different, frequency bands in which the resonance corresponding to the Loop mode is located are different, and frequency bands in which the resonance corresponding to the zero-order mode is located are different. Based on the solution, a limitation on impact of different radiator lengths on a covered frequency band is provided. For example, a radiator length may be adjusted to adjust a frequency band in which the resonance corresponding to the loop mode is located and a frequency band in which the resonance corresponding to the zero-order mode is located.

In a possible design, when structure parameters of the interdigital structure are different, frequency bands in which the resonance corresponding to the zero-order mode is located are different. The structure parameter of the interdigital structure includes at least one of the following: a slot width s that is of the interdigital structure and that is parallel to the first radiator, a slot width g that is of the interdigital structure and that is perpendicular to the first radiator, and a length f that is of the interdigital structure and that is parallel to the first radiator. Based on the solution, a limitation on impact of different sizes of the interdigital structure on operating of the antenna is provided. For example, different parameters in the interdigital structure may be adjusted to adjust a frequency band in which the resonance corresponding to the zero-order mode is located.

In a possible design, the slot width s parallel to the first radiator is included in a range of 0.2 mm±20%, the slot width g that is of the interdigital structure and that is perpendicular to the first radiator is included in a range of 0.3 mm±20%, and the length f that is of the interdigital structure and that is parallel to the first radiator is included in a range of 2.1 mm±20%. Based on the solution, a limitation on a specific setting range of the interdigital structure is provided. Within the foregoing range, the interdigital structure can provide a distributed capacitor that can be suitable for operating in a medium-high frequency band, so that the zero-order mode can provide a good radiation effect.

In a possible design, the first radiator is disposed in a corner of the electronic device, the first radiator includes a first part and a second part that are connected, the first part is disposed on a side edge that is of the electronic device and that corresponds to the corner, the second part is disposed on a bottom edge that is of the electronic device and that corresponds to the corner, the feed point is disposed at an end of the second part, and the ground point is disposed at an end of the first part. Based on the solution, a specific disposing example of the terminal antenna is provided. In this example, the terminal antenna may be disposed in a lower left corner or a lower right corner of the electronic device (for example, a mobile phone). For example, a part of a radiator may be located on a bottom edge of the mobile phone, and the other part of the radiator may be located on a side edge of the mobile phone. In addition, the feed point may be disposed on the bottom edge, and the ground point may be disposed on the side edge. Therefore, both the zero-order mode and the loop mode can better excite a ground current to obtain good radiation performance.

In a possible design, the terminal antenna is disposed on a flexible printed circuit FPC, the first radiator is a conductive structure on the FPC, and the slot is provided on the conductive structure. Based on the solution, a specific implementation of the terminal antenna is provided. A size of the slot directly determines a size of a distributed capacitor, to further affect a frequency band range of the resonance corresponding to the zero-order mode. Therefore, the size of the slot may be precisely controlled by using the FPC, to improve antenna accuracy.

In a possible design, there are two to five slots of the interdigital structure. Based on the solution, a specific limitation on a quantity of interdigital structures is provided. When the quantity of interdigital structures is greater than 2, the zero-order mode can be better excited; and when the quantity of interdigital structures is not greater than 5, a size of the terminal antenna may not be excessively large, thereby meeting a miniaturization requirement.

In a possible design, the terminal antenna further includes a second radiator, the second radiator and the first radiator are not connected to each other, an end that is of the second radiator and that is away from the first part is grounded, and an end that is of the second radiator and that is close to the first part is suspended. Based on the solution, an extension of the solution is provided. In this example, the second radiator may be disposed to form a parasitic structure with the first radiator, so as to extend a covered frequency band.

In a possible design, the operating frequency band of the terminal antenna further includes a third frequency band, the third frequency band is different from the first frequency band or the second frequency band, the third frequency band is covered by the terminal antenna by using a resonance corresponding to a balanced mode, and the resonance corresponding to the balanced mode is generated by the second radiator. Based on the solution, an example operating status used when the second radiator is designed is provided. The second radiator may lead a current on the first radiator to the second radiator in a coupling manner. Because one end of the second radiator is grounded, the balanced mode corresponding to parasitism can be generated. Therefore, the balanced mode may be used to cover the third operating frequency band different from that in the zero-order mode and that in the loop mode, so that a bandwidth and radiation performance of the terminal antenna are improved.

In a possible design, the first frequency band, the second frequency band, and the third frequency band jointly cover 1.7 GHz to 2.7 GHz. Based on the solution, a specific example operating scenario of the terminal antenna is provided. In this example, the terminal antenna may be disposed in a lower part of a mobile phone, and is configured to cover a medium-high frequency band in a dominant frequency band, so as to improve operating performance of the dominant frequency band.

According to a second aspect, an electronic device is provided. The terminal antenna according to any one of the first aspect and the possible designs of the first aspect is disposed in the electronic device. When transmitting or receiving a signal, the electronic device transmits or receives the signal by using the terminal antenna.

It should be understood that technical features of the technical solution provided in the second aspect can all correspond to the terminal slot antenna provided in any one of the first aspect and the possible designs of the first aspect, and therefore similar beneficial effects can be achieved. Details are not described herein again.

### BRIEF DESCRIPTION OF DRAWINGS

FIG. 1 is a schematic diagram of a location of an antenna disposed in a mobile phone;

FIG. 2 is a schematic diagram of composition of a left-handed parasitic antenna;

FIG. 3 is a schematic diagram of a simulation result of a left-handed parasitic antenna;

FIG. 4 is a schematic diagram of composition of an electronic device according to an embodiment of this application;

FIG. 5 is a schematic diagram of a location of a lower antenna region according to an embodiment of this application;

FIG. 6 is a schematic diagram of a topology structure of an antenna solution according to an embodiment of this application;

FIG. 7 is a schematic diagram of a structure of an antenna solution according to an embodiment of this application;

FIG. 8A is a schematic diagram of composition of an antenna solution according to an embodiment of this application;

FIG. 8B is a schematic diagram of an interdigital structure according to an embodiment of this application;

FIG. 9 is a schematic diagram of an interdigital structure according to an embodiment of this application;

FIG. 10 is a schematic diagram of an S parameter of an antenna disposed with an interdigital structure according to an embodiment of this application;

FIG. 11 is a schematic simulation diagram of impact of different structure parameters on an interdigital structure and an operating frequency band of an antenna according to an embodiment of this application;

FIG. 12 is another schematic simulation diagram of impact of different structure parameters on an interdigital structure and an operating frequency band of an antenna according to an embodiment of this application;

FIG. 13 is another schematic simulation diagram of impact of different structure parameters on an interdigital structure and an operating frequency band of an antenna according to an embodiment of this application;

FIG. 14 is a schematic simulation diagram of an operating effect according to an embodiment of this application;

FIG. 15 is a schematic diagram of a topology structure of another antenna solution according to an embodiment of this application;

FIG. 16 is a schematic diagram of a topology structure of another antenna solution according to an embodiment of this application;

FIG. 17 is a schematic diagram of current analysis according to an embodiment of this application;

FIG. 18 is a schematic simulation diagram of an operating effect according to an embodiment of this application; and

FIG. 19 is a schematic simulation diagram of a pattern according to an embodiment of this application.

### DESCRIPTION OF EMBODIMENTS

At least one antenna may be disposed in an electronic device to support a wireless communication function of the electronic device.

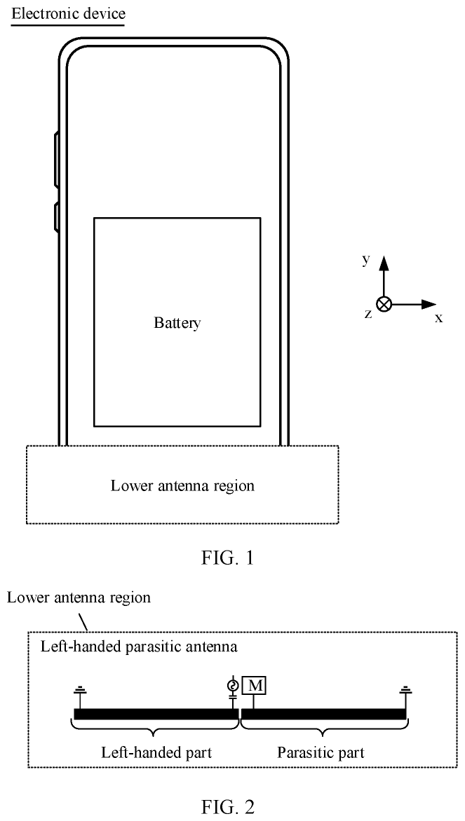

For example, the electronic device is a mobile phone. With reference to FIG. 1, a battery that is disposed inside the mobile phone and that is used to supply power may be disposed in the middle of the mobile phone or at a location lower than the middle of the mobile phone. In the mobile phone, an antenna may be disposed above the battery and/or below the battery. FIG. 1 shows an illustration of a case in which an antenna is disposed below a battery.

It may be understood that currently, most electronic devices support communication in a dominant frequency band of 700 MHz-3 GHz and communication in a local area network of 2.4 GHz/5 GHz. In addition, to meet a communication requirement of a 5G network, an antenna used for 5G communication may be further disposed in the electronic device.

A main antenna that supports data/voice receiving and transmitting in communication in a dominant frequency band is used as an example. In some implementations, because most components such as a chip and a circuit of the electronic device are disposed above the battery, to provide an environment such as better clearance for the main antenna, the main antenna may be disposed in a lower antenna region below the battery shown in FIG. 1.

For example, FIG. 2 shows an illustration of a currently commonly used main antenna. As shown in FIG. 2, in this example, the antenna may be a left-handed parasitic antenna. The left-handed parasitic antenna may include a left-handed part and a parasitic part.

The left-handed part may include a radiator. One end of the radiator may be connected to a feed point, and a left-handed capacitor may be disposed between the feed point and the radiator. The left-handed capacitor may be configured to excite the radiator in the left-handed part to generate a left-handed mode. In this example, the feed point may be disposed at an end that is of the left-handed part and that is close to the parasitic part. An end that is of the radiator in the left-handed part and that is away from the parasitic part may be grounded. For a structure and an operating mechanism of the left-handed antenna, refer to CN201380008276.8 and CN201410109571.9. Details are not described herein.

The parasitic part of the left-handed parasitic antenna may include a radiator, and one end of the radiator may be grounded. For example, as shown in FIG. 2, an end that is of the parasitic part and that is away from the left-handed part may be directly grounded, and a matching (matching, M) circuit may be disposed at an end that is of the parasitic part and that is close to the left-handed part, to tune an operating frequency band and port impedance of the parasitic part.

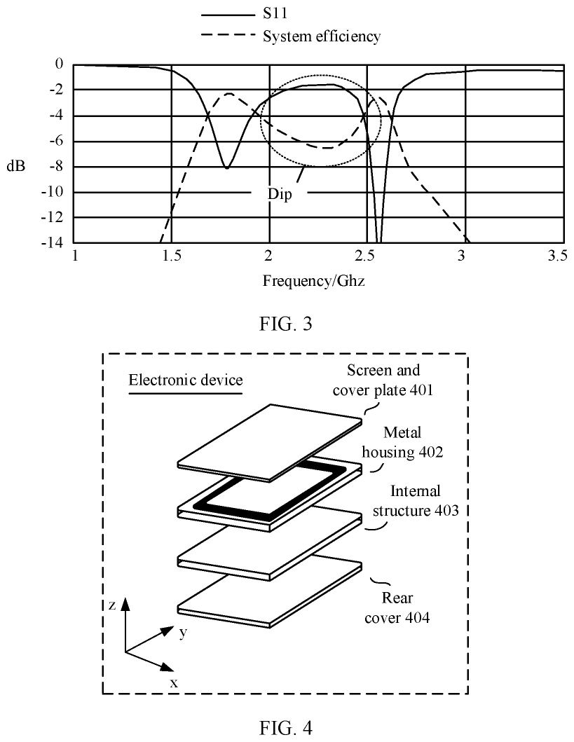

FIG. 3 shows an illustration of a simulation result of a left-handed parasitic antenna having the composition shown in FIG. 2. It can be learned from S11 that the left-handed parasitic antenna may cover 1.7 GHz-2.7 GHz of a medium-high frequency band. The medium-high frequency band may be covered by using two resonances. Due to insufficient bandwidths of the two resonances, return losses at two ends of the medium-high frequency band are poor. In addition, a dip is further generated between the two resonances. For example, as shown in FIG. 2, a significant loss increase is generated between 2 GHz and 2.5 GHz. A similar conclusion may also be reached from a perspective of system efficiency. For example, efficiency near 1.7 GHz and 2.7 GHz is poor, and an efficiency dip is generated between 2 GHz and 2.5 GHz. System efficiency of this part is poorest and is greater than −6 dB.

It should be noted that, generally, when a medium-high frequency band needs to be completely covered, one or more switching switches may be disposed at a feed point and/or a ground point of an antenna, to switch between different operating frequency bands, thereby ensuring coverage of the entire medium-high frequency band.

To resolve a problem that performance of an existing antenna (for example, a left-handed parasitic antenna) is insufficient at an endpoint of a medium-high frequency band, and efficiency in a middle section of the medium-high frequency band (for example, 1.7 GHz-2.7 GHz) is poor, embodiments of this application provide a terminal antenna, to provide, in combination with a current loop antenna and a ½ wavelength mode provided by a Loop, good radiation performance at two ends of a medium-high frequency band and a middle frequency band.

The solution provided in the embodiments of this application is described below with reference to the accompanying drawings.

The antenna solution provided in the embodiments of this application may be applied to an electronic device of a user to support a wireless communication function of the electronic device. For example, the electronic device may be a portable mobile device, such as a mobile phone, a tablet computer, a personal digital assistant (personal digital assistant, PDA), an augmented reality (augmented reality, AR)\virtual reality (virtual reality, VR) device, or a media player. The electronic device may alternatively be a wearable electronic device such as a smartwatch. A specific form of the device is not specially limited in the embodiments of this application.

FIG. 4 is a schematic diagram of a structure of an electronic device 400 according to an embodiment of this application. As shown in FIG. 4, a screen and cover plate 401, a metal housing 402, an internal structure 403, and a rear cover 404 may be sequentially disposed along a z axis from top to bottom in the electronic device 400 provided in this embodiment of this application.

The screen and cover plate 401 may be used to implement a display function of the electronic device 400. The metal housing 402 may be used as a main frame of the electronic device 400, to provide rigid support for the electronic device 400. The internal structure 403 may include a collection of electronic components and mechanical components that implement various functions of the electronic device 400. For example, the internal structure 403 may include a shielding case, a screw, a rib, and the like. The rear cover 404 may be a rear external surface of the electronic device 400, and a glass material, a ceramic material, a plastic material, and the like may be used for the rear cover 404 in different implementations.

The antenna solution provided in the embodiments of this application can be applied to the electronic device 400 shown in FIG. 4, to support a wireless communication function of the electronic device 400. In some embodiments, an antenna in the antenna solution may be disposed on the metal housing 402 of the electronic device 400. In some other embodiments, the antenna in the antenna solution may be disposed on the rear cover 404 or the like of the electronic device 400.

A specific implementation of the antenna may vary in different implementations of the embodiments of this application. For example, in some embodiments, the antenna may be implemented in combination with a metal frame on the metal housing 402 shown in FIG. 4. In some other embodiments, the antenna solution may alternatively be implemented by using a flexible printed circuit (Flexible Printed Circuit, FPC), a metalframe diecasting for anodicoxidation (Metalframe Diecasting for Anodicoxidation, MDA) process, or the like. Alternatively, the antenna solution may be obtained by combining at least two of the foregoing implementations. A specific implementation form of a magnetic flux loop monopole antenna is not limited in this embodiment of this application.

For example, the antenna is implemented by using an FPC. The FPC may include a non-conductive substrate, and a conductive layer may be disposed on the substrate. For example, the conductive layer may be made of metal or another conductive material. In some implementations, the metal may be copper, silver, or the like. A radiator of the antenna is obtained through structural adjustment of the conductive layer. A slot may be connected in series to the radiator, and the slot may be a through slot, to be specific, one slot may divide a radiator into two parts that are not connected to each other. In some implementations, a dielectric filled in the slot may be adjusted, so that a size of a distributed capacitor corresponding to the slot is adjusted by using dielectrics with different dielectric constants.

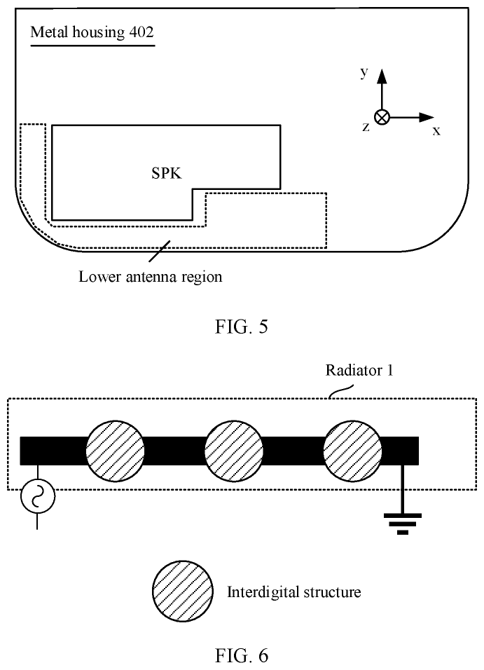

Vertically, the antenna solution provided in the embodiments of this application may be disposed in a lower antenna region of a mobile phone. For example, the lower antenna region may be below the battery shown in FIG. 2. For example, with reference to FIG. 5, in some implementations of this application, the antenna solution provided in this application may be disposed between the metal housing and the rear housing shown in FIG. 4. Alternatively, in the antenna solution, a part of a conductor on the metal housing may be used to implement a radiation function of the antenna.

In terms of horizontal projection (for example, projection on an XOY plane), the lower antenna region may be located below a speaker (speaker, SPK). For example, an antenna bracket made of a non-conductive material may be disposed below the SPK, and an antenna in an FPC process may be attached to the antenna bracket. Alternatively, the antenna solution provided in this application may be implemented on the antenna bracket by using a laser direct structuring (Laser Direct Structuring, LDS) process and/or an MDA process.

In addition, in another implementation, the antenna solution provided in the embodiments of this application may be further applied at another location, for example, may be disposed in another corner of the electronic device, such as an upper left corner or an upper right corner.

The foregoing examples are detailed descriptions of an application environment of the antenna solution provided in the embodiments of this application. Specific composition and an achievable effect of the antenna solution provided in the embodiments of this application are described below with reference to the accompanying drawings.

For example, FIG. 6 shows an example of an antenna solution according to an embodiment of this application. The antenna may include at least one radiator (for example, a radiator 1). One end of the radiator 1 may be connected to a feed point, and the other end of the radiator 1 may be grounded. It should be understood that, in a specific implementation, one or more matching components may be further disposed between the radiator 1 and the feed point and/or a ground point to perform port matching. An example in which the radiator 1 is directly connected to the feed point and the ground point is used below. As shown in FIG. 6, at least one interdigital structure may be further disposed on the radiator 1. The interdigital structure may be a slot of the interdigital structure. In the example in FIG. 6, an example in which three interdigital structures are disposed on the radiator 1 is used. In some other implementations, more or fewer interdigital structures may alternatively be included, and a specific quantity may be flexibly set based on an actual situation. Effects that can be achieved by the interdigital structures are similar, and details are not described herein. In this embodiment of this application, when a quantity of interdigital structures is greater than or equal to 2, a corresponding mode can be better excited, so as to obtain a corresponding resonance to cover a corresponding frequency band.

It may be understood that the interdigital structure can achieve an effect of a distributed capacitor, that is, at least one capacitor may be connected in series to the radiator 1. Therefore, the radiator 1 can obtain a radiation feature of a current loop antenna. For example, a uniform magnetic field may be distributed between the radiator 1 and a reference ground, to obtain good radiation performance in small space.

During operating of an antenna having the composition shown in FIG. 6, in addition to a mode (for example, referred to as a zero-order mode) corresponding to the current loop antenna, the antenna may further operate in a ½ wavelength mode of a loop (Loop) mode, so as to obtain at least two resonances to cover a medium-high frequency band.

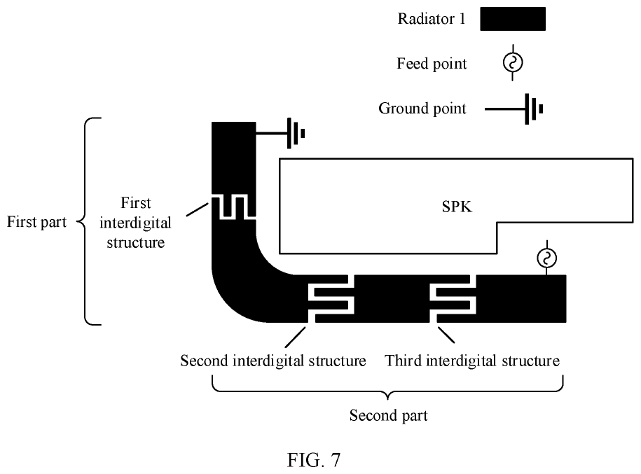

FIG. 7 shows a specific example of the antenna having the topology composition shown in FIG. 6. For example, the antenna may be disposed in a lower antenna region shown in FIG. 5.

As shown in FIG. 7, the radiator 1 included in the antenna may be disposed in a lower left corner of a back view of an electronic device. In some examples, the radiator 1 may include a first part and a second part that are connected. The first part of the radiator may be disposed on a side edge of the electronic device, and the second part of the radiator 1 may be disposed on a bottom edge of the electronic device. Two ends of the radiator 1 may be respectively connected to a feed point and a ground point.

At least one interdigital structure may be disposed on the first part and/or the second part. For example, with reference to FIG. 7, one interdigital structure may be disposed on the first part, and two interdigital structures may be disposed on the second part.

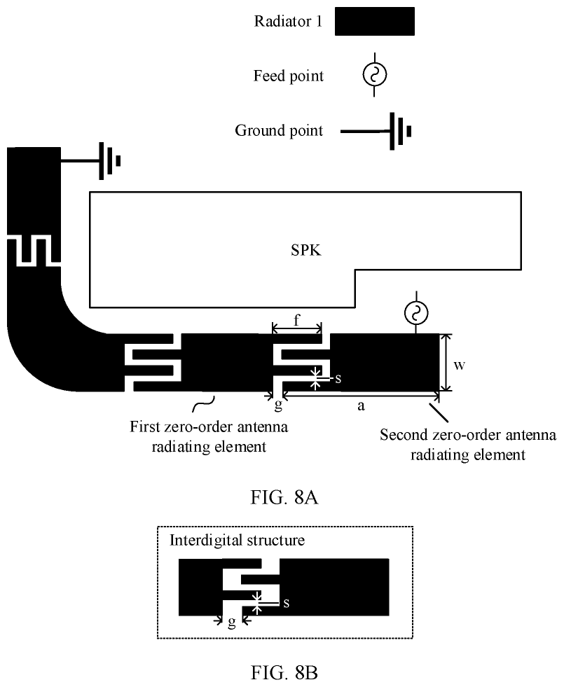

Described from another perspective, one or more interdigital structures on the radiator 1 may split the radiator 1 into a plurality of parts that are not connected to each other. For example, any part that is not connected to another part is referred to as a zero-order antenna radiating element. In different examples, the plurality of zero-order antenna radiating elements may have a same size or may have different sizes. For example, in some embodiments, as shown in FIG. 8A, the radiator 1 may include a first zero-order antenna radiating element and a second zero-order antenna radiating element. An X-direction length a of any zero-order antenna radiating element (for example, the first zero-order antenna radiating element) may be set to fall within a range of 10.5 mm±50%. AY-direction width w may be set to fall within a range of 2 mm±50%.

Ends that are of the first zero-order antenna radiating element and the second zero-order antenna radiating element and that are disposed opposite to each other alternately extend to form an interdigital structure. A slot width s of the interdigital structure (that is, a slot width s parallel to the radiator 1) may fall within a range of 0.2 mm±20%. An X-direction length f of the alternately extended interdigital structure (that is, a length f that is of the interdigital structure and that is parallel to the radiator 1) may be set to fall within a range of 2.1 mm±20%. A slot width g that is of the interdigital structure and that is relative to a zero-order antenna radiating element on the other side (that is, a slot width g that is of the interdigital structure and that is perpendicular to the radiator 1), may be set to fall within a range of 0.3 mm±20%.

It should be noted that, in the solution provided in this embodiment of this application, the slot width s parallel to the radiator 1 may be different from the slot width g that is of the interdigital structure and that is perpendicular to the radiator 1. Impact of the two parameters on a size of a distributed capacitor of the interdigital structure needs to be separately controlled. For example, FIG. 8B shows an illustration of another interdigital structure according to an embodiment of this application. It can be learned that g and s are two significantly different sizes. In the following example, impact of each parameter on an operating frequency band corresponding to a zero-order mode is described with reference to a control variable of the parameter.

It should be understood that, based on equivalent circuit analysis, the interdigital structure may function as a coupling capacitor, and function together with a zero-order antenna radiating element to determine a resonance location in a zero-order mode. To be specific, a size that is of a distributed capacitor and that is affected by each size of the interdigital structure and an overall length of the radiator 1 jointly affect an operating frequency band in which the antenna operates in the zero-order mode. When the zero-order mode corresponds to a fundamental mode, a length of the radiator 1 may be less than ¼ of a corresponding operating frequency band. In addition, sizes of zero-order antenna radiating elements included in the radiator 1 may be the same or approximately the same, or may be different from each other. In this example, a size from a right side of a third interdigital structure to an end that is of the radiator and that is connected to the feed point may match a size of a capacitor of the interdigital structure (for example, a size of a distributed capacitor corresponding to the third interdigital structure) to effectively adjust the operating frequency band in the zero-order mode.

In addition, an antenna having the foregoing structure may further operate in a ½ mode of a Loop (for example, referred to as a Loop mode). An operating frequency band in the Loop mode may be determined by the length of the radiator 1, that is, ½ of the operating frequency band in the Loop mode may correspond to an electrical length of the radiator between the feed point and the ground point of the antenna.

It should be noted that, the interdigital structure in the embodiments of this application may generate coupling capacitance, and the structure may be used as a multi-order coupling resonator to implement a function of the multi-order coupling resonator. In actual design, coupling capacitance required by the zero-order mode may be obtained based on a pass-band feature of a microstrip coupling resonator, to infer each size of the interdigital structure based on the coupling capacitance, so as to control the size of the interdigital structure.

For example, with reference to a simulation structure of S11, the following explains and describes impact caused to an operating frequency band by each size of the interdigital structure (for example, the slot width s parallel to the radiator 1, the length f that is of the interdigital structure and that is parallel to the radiator 1, and the slot width g that is of the interdigital structure and that is perpendicular to the radiator 1).

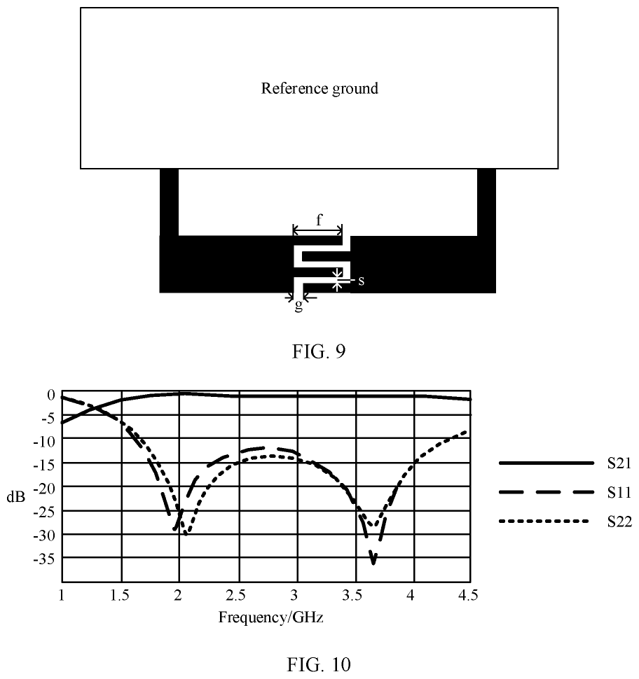

For ease of description, with reference to FIG. 9, an example in which one interdigital structure is disposed is used.

As shown in FIG. 10, in a current structure, a bandwidth formed by dual ports may cover 1.66 MHz-4.32 MHz (S11≤−10 dB), and therefore, a bandwidth requirement in a medium-high frequency band can be effectively met. In addition, FIG. 10 further shows isolation between the dual ports. It may be understood that, capacitance of the interdigital structure in a current size can be analyzed from a perspective of the isolation between the dual ports.

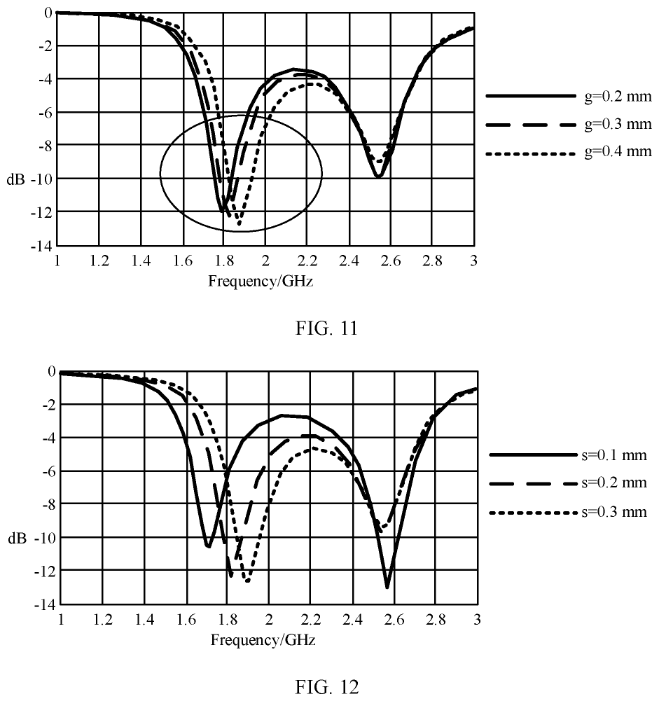

The following FIG. 11-FIG. 13 show impact caused to an S parameter (for example, S11) when a single size is controlled to change.

FIG. 11 shows impact caused to S11 when g is separately 0.2 mm, 0.3 mm, and 0.4 mm in a case of s=0.2 mm and f=2.1 mm. It can be learned that as g increases, a resonance at a low frequency gradually shifts to a higher frequency. It may be understood that as g increases, a capacitance value of a distributed capacitor changes (for example, the capacitance value decreases), and consequently, a frequency shift occurs in the resonance at the low frequency (for example, the resonance shifts to the higher frequency).

FIG. 12 shows impact caused to S11 when s is separately 0.1 mm, 0.2 mm, and 0.3 mm in a case of g=0.3 mm and f=2.1. It can be learned that as s increases, a resonance at a low frequency gradually shifts to a higher frequency. It may be understood that as s increases, a capacitance value of a distributed capacitor changes (for example, the capacitance value decreases), and consequently, a frequency shift occurs in the resonance at the low frequency (for example, the resonance shifts to the higher frequency).

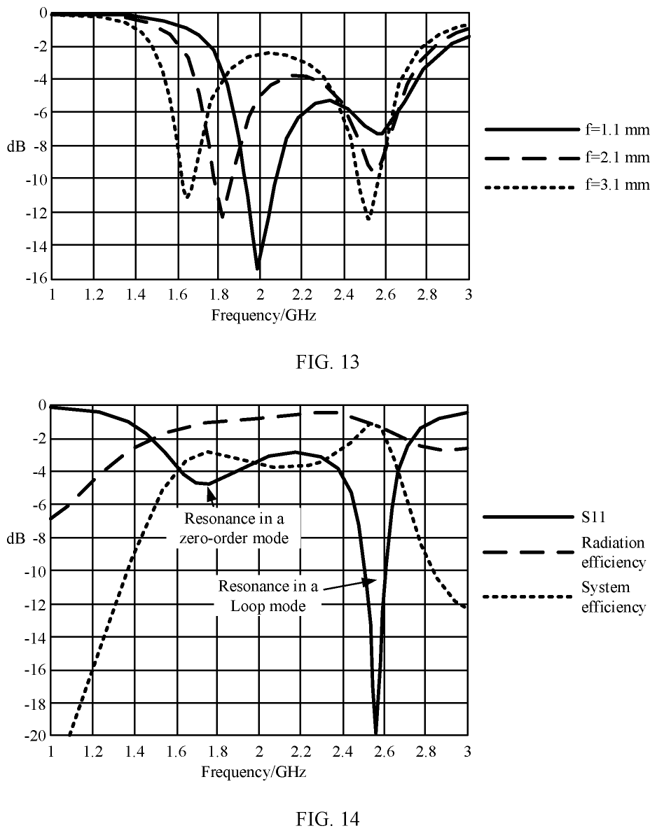

FIG. 13 shows impact caused to S11 when f is separately 1.1 mm, 2.1 mm, and 3.1 mm in a case of g=0.3 mm and s=0.2 mm. It can be learned that as f increases, a resonance at a low frequency gradually shifts to a lower frequency. It may be understood that as f increases, a capacitance value of a distributed capacitor changes (for example, the capacitance value increases), and consequently, a frequency shift occurs in the resonance at the low frequency shifts (for example, the resonance shifts to the lower frequency).

With reference to the illustrations of the S parameter in FIG. 11, FIG. 12, and FIG. 13, it can be learned that a change in s and g mainly affects a location of a resonance at a low frequency, and the resonance is the resonance corresponding to the zero-order mode. However, a change in f causes a change in capacitance, and therefore also affects the resonance corresponding to the zero-order mode. However, an operating frequency band (that is, a resonance) in the Loop mode located at a high frequency is related to an overall size of a radiator. Therefore, a change in s and g has little impact on the Loop mode, and a change in f causes a corresponding change of the Loop mode.

Based on the foregoing conclusion, an operating frequency band having one interdigital structure shown in FIG. 9 may be adjusted. The conclusion may be further extended to a structure in which more interdigital structures are disposed. For example, when an antenna has the structure shown in FIG. 6, FIG. 7, or FIG. 8A, an operating frequency band may also be adjusted based on the foregoing conclusion, so that two resonances corresponding to the zero-order mode and the loop mode can be adjusted to a required frequency band.

In addition, in some embodiments of this application, the feed point may be disposed at a point at which electric field strength is relatively large (for example, a location that is on a bottom edge of a mobile phone and that is close to the middle) on the ground, so that a ground current can be better excited, to obtain better radiation performance in the zero-order mode.

It should be noted that, in all the foregoing examples, an example in which the distributed capacitor is implemented by using the interdigital structure to implement the current loop antenna is used for description. In some other embodiments of this application, one or more of capacitors connected in series to a radiator (for example, the radiator 1) may be implemented by using a lumped capacitor (for example, a capacitor component or an adjustable capacitor component).

Based on the foregoing description, an embodiment of this application further provides a simulation illustration of an antenna solution having the composition shown in FIG. 7 or FIG. 8A, to prove that the antenna solution has good radiation performance.

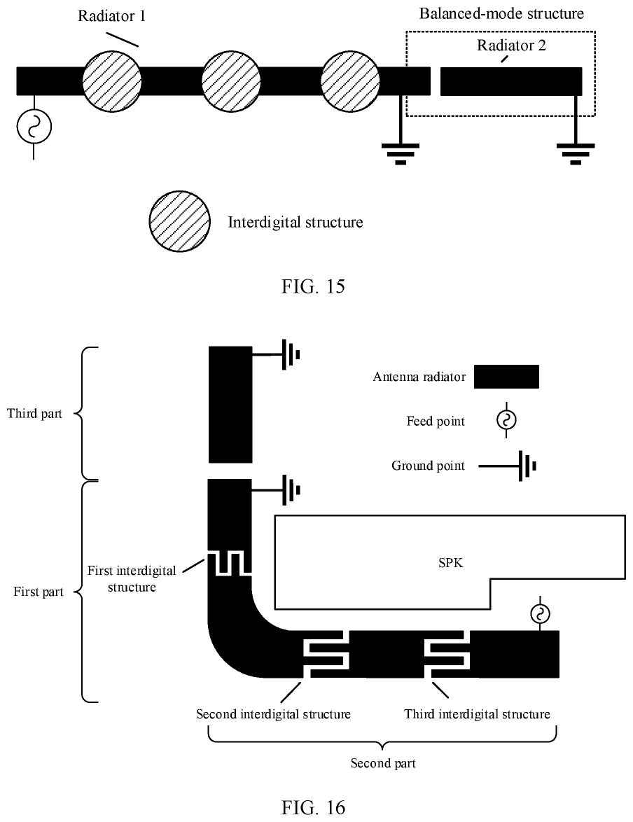

For example, with reference to FIG. 14, it can be learned that the resonance in the zero-order mode may be used to cover a lower frequency in a medium-high frequency band, and the resonance in the loop mode may be used to cover a higher frequency in the medium-high frequency band. Although a protrusion is generated in S11 in a middle section of the medium-high frequency band, because bandwidths in the two modes are sufficient, radiation performance is good in an entire range of the medium-high frequency band including the middle section from perspectives of radiation efficiency and system efficiency. For example, radiation efficiency between 1.7 GHz and 2.7 GHz is at least −2 dB, and system efficiency between 1.7 GHz and 2.7 GHz is at least −4 dB. Compared with radiation performance of the existing left-handed parasitic antenna in the foregoing description, radiation performance is greatly improved. Therefore, the antenna solution provided in this example has a better bandwidth and can better cover a sideband by using two resonances, and there is no significant protrusion in a middle region because bandwidths of the two resonances are sufficient. Therefore, a medium-high frequency band is well covered, thereby providing good radiation performance.

In the antenna solution provided in the foregoing example, the resonances in the two modes, that is, the zero-order mode and the loop mode, are used to well cover the medium-high frequency band. In some other embodiments of this application, application of the zero-order mode and the loop mode may be further combined with another antenna form, to cover a part of a medium-high frequency band in a dominant frequency band. In some other embodiments of this application, an antenna solution having any one of the possible composition in FIG. 6-FIG. 8A can be further applied to coverage of another operating frequency band, for example, used to cover WI-FI or 5G. Based on a similar mechanism in the foregoing description, the zero-order mode and the loop mode can also well cover a corresponding frequency band, and details are not described herein.

An embodiment of this application further provides an antenna solution. Based on the zero-order mode and the loop mode, a balanced mode is additionally set to provide more resonances (for example, a total of three resonances), so as to further improve bandwidth coverage, thereby improving radiation performance.

For example, FIG. 15 shows an illustration of a topology of an antenna solution. That a zero-order mode is implemented by using an interdigital structure is still used as an example for description. The topology illustration is shown with reference to FIG. 6. In this example, based on the structure shown in FIG. 6, a balanced-mode structure is further additionally disposed. In a possible implementation, the balanced-mode structure may include a radiator 2. One end of the radiator 2 may be grounded, and the other end may be disposed opposite to the grounded end of the radiator 1. For example, in the example shown in FIG. 6, the grounded end of the radiator 2 may be an end away from the radiator 1, and a non-grounded end of the radiator 2 may be disposed near the radiator 1. This non-grounded end is suspended. In this way, during operating of an antenna, energy may be coupled to the radiator 2 from the radiator 1, so that the radiator 2 achieves a parasitic effect, thereby obtaining radiation in the corresponding balanced mode.

FIG. 16 shows a specific implementation based on the topology structure in FIG. 15. The implementation may be obtained through evolution based on the antenna structure shown in FIG. 7 or FIG. 8A. For example, based on FIG. 7 or FIG. 8A, the radiator in the antenna solution may further include a third part. The third part may correspond to the balanced-mode structure shown in FIG. 15. In this example, the third part may include a radiator whose first part and second part are not connected to each other. In some embodiments, a part or all of the third part may be implemented by sharing a side metal frame of an electronic device (for example, a mobile phone). In some other embodiments, a part or all of the third part may alternatively be implemented by disposing a separate LDS structure, FPC structure, or the like.

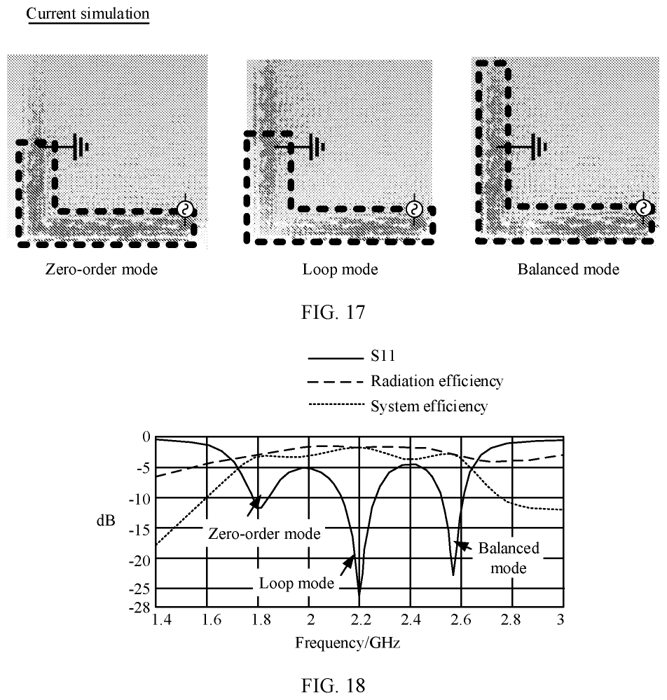

In an operating process of the antenna, the third part can provide a resonance other than that in the zero-order mode and that in the loop mode, for example, a resonance in the balanced mode, which can further increase a bandwidth of the antenna, thereby providing better radiation performance. For example, an operating mechanism of the antenna solution provided in this embodiment of this application is described with reference to current simulation shown in FIG. 17.

As shown in FIG. 17, when the zero-order mode operates, currents are concentrated between the feed point and the ground point, and a current loop structure is formed between the radiator and the reference ground, so as to obtain an operating mechanism of the zero-order mode. When the loop mode operates, the currents are still concentrated between the feed point and the ground point, and there is a current zero on the radiator, so that the current is inverted to obtain the loop mode that operates at a ½ wavelength. In addition, the antenna may further operate in the balanced mode. In this mode, currents may be distributed on all radiators of the antenna. For example, the current on a side radiator (that is, the first part and the third part) is large, so that a radiation mechanism of the balanced mode can be formed.

Therefore, the foregoing three types of operating mechanisms corresponding to different frequency bands are excited, so that three resonances can be simultaneously obtained to cover an operating frequency band, to obtain a better bandwidth and better radiation performance.

For example, FIG. 17 shows a simulation illustration of an antenna solution having the composition shown in FIG. 15 or FIG. 16. It can be learned that in this example, the three resonances can be used to cover a medium-high frequency band. It can be learned from S11 that, because the resonance in the balanced mode is added, the resonance in the loop mode may be tuned to be near the middle section (for example, 2.2 GHz), a rear section of the medium-high frequency band may be covered by the resonance in the balanced mode, and the resonance in the zero-order mode may still be used to cover a front section of the medium-high frequency band. In this way, S11 in the entire medium-high frequency band can be approximately below −5 dB as a whole. Correspondingly, compared with a case in which two resonances are used to cover the medium-high frequency band, a protrusion in the middle section for radiation efficiency is compensated for, and overall system efficiency is also improved, which exceeds −4 dB in a full frequency band. Certainly, in some other embodiments of this application, a covered frequency band and/or a sequence of each mode may be further adjusted based on an actual situation, to well cover a corresponding operating frequency band.

With reference to the description in FIG. 15-FIG. 18, it can be learned that in this example, the balanced mode is added, so that resonances corresponding to three modes including the zero-order mode, the loop mode, and the balanced mode are obtained. Compared with an existing antenna solution, for example, a left-handed parasitic solution, a better bandwidth and better radiation performance can be provided.

In addition, because the zero-order mode, the loop mode, and the balanced mode can be excited without an additional switching switch, compared with the existing left-handed parasitic antenna solution, the solution provided in the embodiments of this application is more convenient to implement, and corresponding costs and overheads can be reduced. In addition, because no switch needs to be disposed on a link, problems such as mismatching and a loss corresponding to a switch component do not exist.

It should be noted that in all the foregoing descriptions of specific implementations of this application, that the antenna is disposed in the lower left corner of the back view of the electronic device is used as an example. In some other embodiments of this application, the antenna may alternatively be disposed in another part of the lower antenna region, and based on a similar mechanism, the zero-order mode and the loop mode are excited, or the zero-order mode, the loop mode, and the balanced mode are excited, to better cover a medium-high frequency band and provide better radiation performance.

For a general antenna solution, when radiation performance is improved, an SAR of the antenna solution is also improved accordingly. To protect a user and meet each market access requirement, an antenna solution in an electronic device further needs to ensure that the SAR does not exceed a standard while providing good radiation performance.

The antenna solution provided in the embodiments of this application, for example, the antenna solution provided in FIG. 6-FIG. 14 and the antenna solution provided in FIG. 15-FIG. 18, can provide a good SAR while providing good radiation performance.

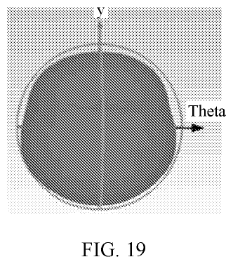

It should be understood that in some cases, when an antenna pattern is uniform in all directions, it indicates that energy distribution in radiation in a space field is dispersed, and the SAR is not locally excessively high due to excessively concentrated currents. FIG. 19 shows a simulation example of a pattern of an antenna having the composition shown in FIG. 15 or FIG. 16. It can be learned that on the plane, the pattern of the antenna is uniformly distributed in all directions, and there is no significant depression or protrusion. Therefore, a space field distribution of the antenna is uniform, and the SAR is lower.

For example, Table 1 shows a measurement result of an SAR value in the antenna solution in a medium-high frequency band. All SAR values are measured by using normalized 18 dBm.

TABLE 1

| | Bottom | Bottom | Back | Back | Left | Left |
|---|---|---|---|---|---|---|
| | surface | surface | surface | surface | side | side |
| | 5 mm | 0 mm | 5 mm | 0 mm | 5 mm | 0 mm |
| Frequency/ | SAR | SAR | SAR | SAR | SAR | SAR |
| MHz | 10 g | 10 g | 10 g | 10 g | 10 g | 10 g |
| 1720 | 0.84 | 1.86 | 0.81 | 1.89 | 0.11 | 0.28 |
| 1735 | 0.84 | 1.59 | 0.83 | 1.86 | 0.11 | 0.28 |
| 1747.5 | 0.83 | 1.41 | 0.81 | 1.69 | 0.11 | 0.28 |
| 1930 | 0.84 | 1.45 | 0.72 | 1.68 | 0.11 | 0.33 |
| 1950 | 0.83 | 1.45 | 0.69 | 1.69 | 0.11 | 0.34 |
| 1970 | 0.81 | 1.45 | 0.67 | 1.71 | 0.11 | 0.35 |
| 2510 | 0.11 | 0.34 | 0.59 | 1.62 | 0.37 | 0.85 |
| 2535 | 0.10 | 0.34 | 0.58 | 1.65 | 0.39 | 0.84 |
| 2560 | 0.11 | 0.33 | 0.56 | 1.63 | 0.40 | 0.85 |

As shown in Table 1, in a medium-high frequency band range, SAR values on the bottom surface, the back surface, and the left side of the disposed antenna are low. Therefore, an additional SAR reduction solution (for example, power backoff is performed by using an SAR sensor (SAR sensor)) is not required while good radiation performance is provided. In this way, the solution is simpler and easier to implement, and response costs and overheads can be reduced.

Although this application is described with reference to specific features and embodiments, it is clear that various modifications and combinations may be made to this application without departing from the scope of this application. Correspondingly, this specification and the accompanying drawings are merely example description of this application defined by the appended claims and are considered to cover any and all of modifications, variations, combinations, or equivalents that cover the scope of this application. Clearly, a person skilled in the art can make various modifications and variations to this application without departing from the spirit and scope of this application. In this way, this application is also intended to include these modifications and variations made to this application if they fall within the scope of the claims of this application and equivalent technologies thereof.

1. A terminal antenna, wherein the terminal antenna is disposed in an electronic device, and the terminal antenna comprises: a first radiator, a feed point, and a ground point;
one end of the first radiator is grounded by using the ground point, and the other end of the first radiator is provided with the feed point; and
the first radiator is further provided with a slot that penetrates the first radiator, the slot is of an interdigital structure, and there are at least two slots.

2. The terminal antenna according to claim 1, wherein an operating frequency band of the terminal antenna comprises at least a first frequency band and a second frequency band, the terminal antenna covers the first frequency band by using a resonance corresponding to a zero-order mode, the resonance corresponding to the zero-order mode is generated by the slot of the interdigital structure, the terminal antenna covers the second frequency band by using a resonance corresponding to a Loop mode, and the first frequency band is different from the second frequency band.

3. The terminal antenna according to claim 2, wherein the slot is filled with a dielectric, the dielectric and the first radiator have different dielectric constants, and when the slot is filled with different dielectrics, the resonance corresponding to the zero-order mode covers different frequency bands.

4. The terminal antenna according to claim 2, wherein when lengths of the first radiator are different, frequency bands in which the resonance corresponding to the Loop mode is located are different, and frequency bands in which the resonance corresponding to the zero-order mode is located are also different.

5. The terminal antenna according to claim 2, wherein when structure parameters of the interdigital structure are different, frequency bands in which the resonance corresponding to the zero-order mode is located are different; and
the structure parameter of the interdigital structure comprises at least one of the following:
a slot width (s) that is of the interdigital structure and that is parallel to the first radiator, a slot width (g) that is of the interdigital structure and that is perpendicular to the first radiator, and a length (f) that is of the interdigital structure and that is parallel to the first radiator.

6. The terminal antenna according to claim 5, wherein
the slot width (s) parallel to the first radiator is comprised in a range of 0.2 mm±20%, the slot width (g) that is of the interdigital structure and that is perpendicular to the first radiator is comprised in a range of 0.3 mm±20%, and the length (f) that is of the interdigital structure and that is parallel to the first radiator is comprised in a range of 2.1 mm±20%.

7. The terminal antenna according to claim 1, wherein the first radiator is disposed in a corner of the electronic device;
the first radiator comprises a first part and a second part that are connected, the first part is disposed on a side edge that is of the electronic device and that corresponds to the corner, and the second part is disposed on a bottom edge that is of the electronic device and that corresponds to the corner; and
the feed point is disposed at an end of the second part, and the ground point is disposed at an end of the first part.

8. The terminal antenna according to claim 1, wherein the terminal antenna is disposed on a flexible printed circuit, the first radiator is a conductive structure on the flexible printed circuit, and the slot is provided on the conductive structure.

9. The terminal antenna according to claim 1, wherein there are two to five slots of the interdigital structure.

10. The terminal antenna according to claim 1, wherein the terminal antenna further comprises a second radiator, the second radiator and the first radiator are not connected to each other, an end that is of the second radiator and that is away from the first part is grounded, and an end that is of the second radiator and that is close to the first part is suspended.

11. The terminal antenna according to claim 10, wherein the operating frequency band of the terminal antenna further comprises a third frequency band, the third frequency band is different from the first frequency band or the second frequency band, the third frequency band is covered by the terminal antenna by using a resonance corresponding to a balanced mode, and the resonance corresponding to the balanced mode is generated by the second radiator.

12. The terminal antenna according to claim 1, wherein the first frequency band, the second frequency band, and the third frequency band jointly cover 1.7 GHz to 2.7 GHz.

13. An electronic device, wherein the terminal antenna according to claim 1 is disposed in the electronic device, and when transmitting or receiving a signal, the electronic device transmits or receives the signal by using the terminal antenna.
